(19) United States
(12) Patent Application Publication
(10) Pub. No.: US 2012/0211472 A1
(43) Pub. Date: Aug. 23, 2012

(54) WELDING SYSTEM WITH ROTATIONAL SPEED CONVERTER FOR AUXILIARY POWER GENERATOR

(75) Inventor: Samir F. Farah, Broadview Heights, OH (US)

(73) Assignee: Lincoln Global, Inc., Industry, OH (US)

(21) Appl. No.: 13/032,336

(22) Filed: Feb. 22, 2011

(51) Int. Cl. B23K 11/24

(52) U.S. Cl. 219/108; 219/117.1

(57) ABSTRACT

A welding system includes an engine having a rotational power output, an AC welding generator operatively connected to the rotational power output for generating an AC current, a rectifying circuit electrically connected to the AC welding generator for converting the AC current to a DC output for welding, an auxiliary power generator for supplying AC power to an auxiliary electrically powered device, and a rotational speed adjuster coupling the auxiliary power supply to the rotational power output and configured to drive the auxiliary power supply at a different rotational rate than a rotational rate of the rotational power output.

### TECHNICAL FIELD

The present disclosure relates to welding systems, and more specifically, to a welding system with a rotational speed converter for an auxiliary power generator.

### BACKGROUND

Welding is an important process in the manufacture and construction of various products and structures. Applications for welding are widespread and used throughout the world including, for example, the construction and repair of ships, buildings, bridges, vehicles, and pipe lines, to name a few. Welding is performed in a variety of locations, such as in a factory with a fixed welding operation or on site with a portable welder.

In automated or mechanized welding a user/operator (i.e. welder) programs or instructs welding equipment to make a weld. For example, in Submerged Arc Welding (SAW) a consumable solid or tubular (flux cored) electrode may be continuously fed into a molten weld or arc zone that is protected from atmospheric contamination by being “submerged” under flux such as a blanket of granular fusible material consisting of lime, silica, manganese oxide, calcium fluoride, or other suitable compounds. Generally, when molten, the flux becomes conductive, and provides a current path between the electrode and the work piece. A thick layer of flux completely covering the molten metal may thus prevent spatter and sparks as well as suppress the intense ultraviolet radiation and fumes that may be a part of the arc welding process. In such a process, currents ranging from 300 to 2000 A may be utilized. Additionally, currents of up to 5000 A may be used with multiple arcs. Single or multiple electrode wire variations of the process exist. Also, DC or AC power can be used, and/or combinations of DC and AC in multiple electrode systems. Generally, constant voltage welding power supplies are most commonly used; however, constant current systems in combination with a voltage sensing wire-feeder are also available.

In manual or semi-automated welding a user/operator (i.e. welder) directs welding equipment to make a weld. For example, in electric arc welding the welder may manually position a welding rod or welding wire and produce a heat generating arc at a weld location. In this type of welding, the spacing of the electrode from the weld location is related to the arc produced and to the achievement of optimum melting/fusing of the base and welding rod or wire metals. The quality of such a weld is often directly dependant upon the skill of the welder.

### SUMMARY OF THE INVENTION

In at least one embodiment, a welding system includes an engine having a rotational power output, an AC welding generator operatively connected to the rotational power output for generating an AC current, a rectifying circuit electrically connected to the AC welding generator for converting the AC current to a DC output for welding, an auxiliary power generator for supplying AC power to an auxiliary electrically powered device, and a rotational speed adjuster coupling the auxiliary power supply to the rotational power output and configured to drive the auxiliary power supply at a different rotational rate than a rotational rate of the rotational power output.

Various aspects will become apparent to those skilled in the art from the following detailed description and the accompanying drawings.

### BRIEF DESCRIPTION OF THE DRAWINGS

FIG. 1 is a schematic view of a welding environment; and

FIG. 2 is a schematic view of a welding system according to one embodiment of the present invention.

### DETAILED DESCRIPTION

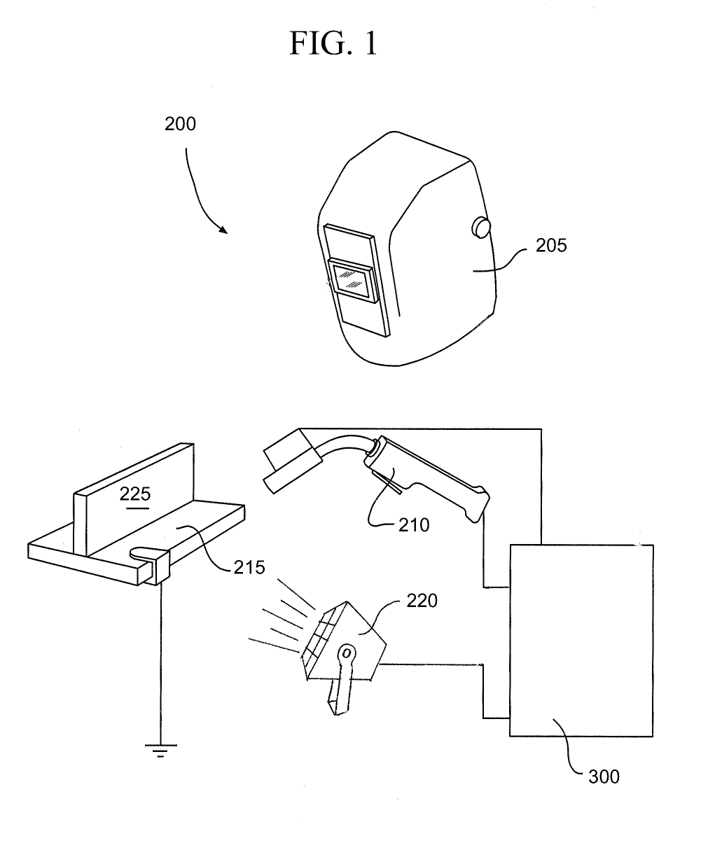

Referring to the drawings, which are illustrative of several embodiments, FIG. 1 illustrates a welding environment 200. The welding environment 200 may include a welder or welding operator 205, a welding system 300, a welding gun or welding electrode 210, a work piece 215, and an auxiliary electrically powered device, such as a work light, 220. The welding environment may also, for example, include a stick electrode holder, TIG torch or other apparatus for use with electric arc welding or other mechanized welding devices. The work piece 215 generally defines a welding work area 225 where the welding gun or welding electrode 210 may be used to form a weld. Various types of exemplary welding, including Shielded Metal Arc Welding (SMAW), Gas Metal Arc Welding (GMAW) e.g. MIG welding, and Gas Tungsten Arc Welding (GTAW) e.g. TIG welding, may be conducted in the welding environment.

As will be further described in part below, the welding system 300 includes welding equipment for generating a welding current and voltage, a welding control system for controlling the welding current and voltage, and a monitoring system for monitoring the welding current and voltage as necessary. The monitoring system may also monitor a variety of other operating parameters, such as but not limited to, welding wire feed speed, amount of welding wire remaining, any type of welding feedback desired by the operator, and any other desired operating parameters.

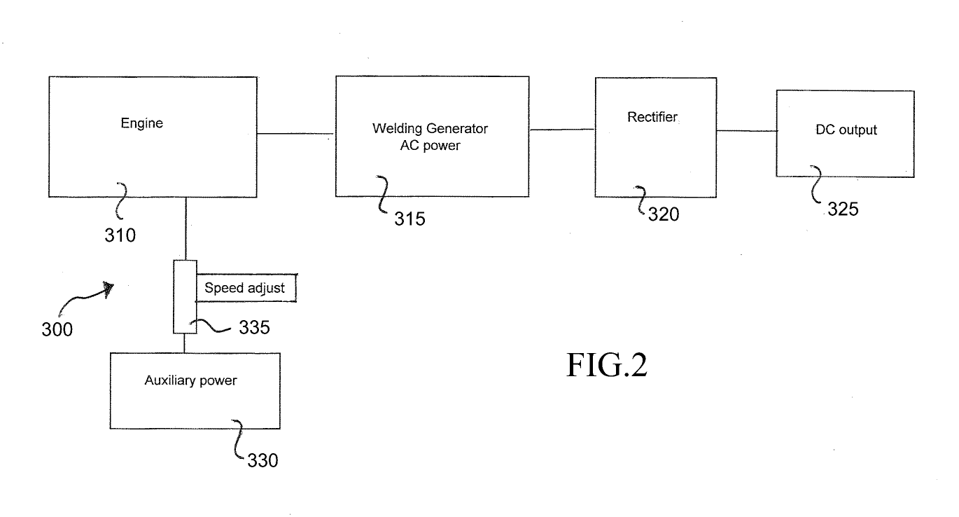

Referring now to FIG. 2, the welding system 300 includes an engine 310 having a rotational power output. The engine 310 may be a gasoline or diesel power internal combustion engine, or any other engine suitable to prove the rotational power to drive a generator. An AC welding generator 315 is operatively connected to the rotational power output of the engine 310 for generating an AC current. A rectifying circuit 320 is electrically connected to the AC welding generator for converting the AC current to a DC output 325 for welding. The rectifier 320 may include other electrical components as desired, such as choppers, inverters and the like

The welding system 300 also includes an auxiliary power generator 330 for supplying AC power to an auxiliary electrically powered device, such as the device 220 illustratively depicted in FIG. 1 as a work light, although, it must be understood that the device 220 may be any desired suitable electrically driven piece of equipment. The auxiliary power generator 330 is configured to provide electrical power in a condition that is compatible for an auxiliary electrically powered device. For example, AC electrical power is generally required to be at 60 Hz in North America and at 50 Hz in Europe and most of Asia. As such, the auxiliary power generator may be configured to provide auxiliary power at or about 50 or 60 Hz. There are generally accepted tolerances in electrical-mechanics as to the frequency of AC power. When referring to the auxiliary power at or about 50 or 60 Hz, it must be understood that one skilled in the art of electrical-mechanical devices will understand the range upon which such a device may operate.

Additionally, the system 300 includes a rotational speed adjuster 335 coupling the auxiliary power generator 330 to the rotational power output of the engine 310. The rotational speed adjuster 335 is configured to drive the auxiliary power generator 330 at a different rotational rate than a rotational rate of the rotational power output of the engine 310.

For example, the rotational speed adjuster 335 may include a pulley system. The pulley system may have a first pulley connected to the rotational power output of the engine 310 and a second pulley connected to an input of the auxiliary power generator 330. The pulleys may be sized to created the desired drive ratio between the engine 310 and the auxiliary power generator 330. The pulleys may be coupled by at least one of a cable, a belt and a chain or any other device suitable to transmit power from one pulley to another.

For further example, the rotational speed adjuster may include a transmission. The transmission may include several manually or automatically selectable gears to provide for multiple gear ratios. Alternatively, the transmission may include a continuously variable transmission that is manually or automatically set to a desired output speed and then adjusts to the input speed from the output of the engine 310.

In one embodiment, the speed adjuster 335 allows the engine to run at a relatively high rate for the generation of AC current for welding by the welding generator 315 while providing a relatively lower rotational speed to the auxiliary power generator. Thus, the system 300 may include an engine 310 that in at least one embodiment may be operated above the rotational speed of the auxiliary power generator 330, while maintaining the functionality of the auxiliary power generator 330.

In operation, once the system 300 is provided, the engine 310 may be run to drive the AC welding generator 315 and the auxiliary power generator 330 via the speed adjuster 335. A current is then produced with the AC welding generator 315 for converting with the rectifying circuit 320 to the DC output 325 for welding. The speed adjuster 335 will then be adjusting the rotational output speed of the engine 310 for the auxiliary power generator 330 and an AC current may be produced from the auxiliary power generator 330 for an auxiliary electrically power device, such as the device 220, at a rotational speed provided by the rotational speed adjuster.

In at least one embodiment, a welding system includes an engine that may be run up to its highest rated output that it can deliver to drive a welding generator. The output from the welding generator may then be rectified and the resulting DC power can be used for welding purposes. For engines rated over 1500 or 1800 RPMs, this will result in a higher engine running speed than would be possible if the engine were limited to 1500 or 1800 RPMs for the generation of auxiliary power.

For example, in such a case, an engine rated in the range of 2400 RPMs may run at or near the top rated RPM. It may be the case that the optimal power production or most fuel efficient operation may be above the previously required 1500 or 1800 RPMs and thus the engine may run more optimally or efficiently than would otherwise be the case. In such a case, a direct drive may drive the welding generator while the engine drives the auxiliary power generator via a speed adjuster. It is to be understood that a stator/rotor may be mounted to the speed adjuster in the same enclosure and the proper voltage/frequency can be generated. So, while the speed adjuster and auxiliary power generator have been illustrated as separate components, it must be understood that they may be parts of one integrated component. Thus, the system may provide auxiliary power outputs of 60 Hz and/or 50 Hz auxiliary, depending on the application, without compromising the engine output to the welding generator.

It must further be understood that in at least one embodiment a welding system may include a speed adjuster and control as to obtain a range of desired RPMs to the auxiliary power generator and this a variety of output frequencies.

It is expected that in at least one embodiment, while the engine is running at a relatively higher RPM than would otherwise be the case, a greater airflow may be achieved for cooling the components of the welding system.

Further, while it has been described to have a welding system with AC welding generator that rectifies the AC output to DC welding power, it must be understood that it is contemplated to have a welding system with a DC welding generator that directly outputs DC welding power without the need rectify the power. Thus, a welding system may include a DC welding generator and an AC auxiliary power generator.

While principles and modes of operation have been explained and illustrated with regard to particular embodiments, it must be understood, however, that this may be practiced otherwise than as specifically explained and illustrated without departing from its spirit or scope.

What is claimed is:

1. A welding system comprising:
an engine having a rotational power output,
a welding generator operatively connected to the rotational power output for generating a current,
an auxiliary power generator for supplying AC power to an auxiliary electrically powered device, and
a rotational speed adjuster coupling the auxiliary power supply to the rotational power output and configured to drive the auxiliary power supply at a different rotational rate than a rotational rate of the rotational power output.

2. The welding system of claim 1 where the welding generator is an AC welding generator operatively connected to the rotational power output for generating an AC current, and the welding system further comprises:
a rectifying circuit electrically connected to the AC welding generator for converting the AC current to a DC output for welding.

3. The welding system of claim 1 where the welding generator is an DC welding generator operatively connected to the rotational power output for generating an DC current to a DC output for welding.

4. The welding system of claim 1 where the rotational speed adjuster includes a pulley system.

5. The welding system of claim 4 where the pulley system includes a first pulley connect to the rotational power output and a second pulley connected to an input of the auxiliary power generator.

6. The welding system of claim 5 where the first and second pulleys are coupled by at least one of a cable, a belt and a chain.

7. The welding system of claim 1 where the rotational speed adjuster includes a transmission.

8. The welding system of claim 7 where the transmission includes multiple gear ratios.

9. The welding system of claim 7, where the transmission is a continuously variable transmission.

10. The welding system of claim 1, where the speed adjuster is configured to drive the auxiliary power generator at a lower rotational speed than the welding generator.

11. The welding system of claim 1, where the speed adjuster is configured to drive the auxiliary power generator at about 50 Hz.

12. The welding system of claim 1, where the speed adjuster is configured to drive the auxiliary power generator at about 60 Hz

13. A method of operating a welding system comprising:
(a.) providing a welding system including an engine having a rotational power output,
a welding generator operatively connected to the rotational power output for generating a current,
an auxiliary power generator for supplying AC power to an auxiliary electrically powered device, and
a rotational speed adjuster coupling the auxiliary power supply to the rotational power output and configured to drive the auxiliary power supply at a different rotational rate than a rotational rate of the rotational power output,
(b.) running the engine to drive the welding generator and the speed adjuster,
(c.) producing a current with the welding generator,
(d.) adjusting the rotational output speed of the engine with the rotational speed adjuster, and
(e.) producing an AC current from the auxiliary power generator for an auxiliary electrically power device at a rotational speed provided by the rotational speed adjuster.

14. The method of operating a welding system of claim 13 where the adjusting in step (d.) includes adjusting the rotational output speed of the engine to a lower rotational speed.

15. The method of operating a welding system of claim 13 where the adjusting in step (d.) includes adjusting the rotational output speed of the engine to about 50 Hz.

16. The method of operating a welding system of claim 13 where the adjusting in step (d.) includes adjusting the rotational output speed of the engine to about 60 Hz.

17. A welding system comprising:
an engine having a rotational power output,
a welding generator operatively connected to the rotational power output for generating a current,
an auxiliary power generator for supplying AC power to an auxiliary electrically powered device, and
a means for adjusting the rotational speed of the rotational power output and configured to drive the auxiliary power supply at a different rotational rate than a rotational rate of the rotational power output.

18. The welding system of claim 17 where the means for adjusting the rotational speed of the rotational power output is configured to drive the auxiliary power supply at a rotational rate slower than the rotational rate of the rotational power output.

19. The welding system of claim 17 where the means for adjusting the rotational speed of the rotational power output is configured to drive the auxiliary power supply at a rate of about 50 Hz.

20. The welding system of claim 17 where the means for adjusting the rotational speed of the rotational power output is configured to drive the auxiliary power supply at a rate of about 60 Hz.
